(19) United States
(12) Patent Application Publication
(10) Pub. No.: US 2007/0000675 A1
(43) Pub. Date: Jan. 4, 2007

(54) Hammer

(76) Inventors: Stefan Sell, Mainz (DE); Michael Stirm, Oberursel (DE)

Correspondence Address: Sr. Group Patent Counsel;Black & Decker Corporation, 701 E. Joppa Rd, Mail Stop TW199, Towson, MD, 21286, US

(21) Appl. No.: 11/352,474

(22) Filed: Feb. 10, 2006

(30) Foreign Application Priority Data
Feb. 10, 2005 (GB) GB 05 027 20.6

(51) Int. Cl. B25D 11/00

(52) U.S. Cl. 173/90

(57) ABSTRACT

A hammer comprising: a housing 2; a motor mounted within the housing; a tool holder 8 rotatably mounted on the housing 2 for holding a cutting tool; a striker mounted in a freely slideable manner within the housing, for repetitively striking an end of a cutting tool when a cutting tool is held by the tool holder 8, which striker is reciprocatingly driven by the motor, when the motor is activated, via a drive mechanism; wherein the drive mechanism comprises: a pivoting drive arm pivotally mounted within the housing 2 at one end; a pivotal drive mechanism connected to the pivoting drive arm which converts a rotary movement generated by the motor to a pivoting movement of the pivoting drive arm about its pivot point the pivotal drive mechanism comprising a circular cam formed around the circumference of a lengthwise section of a rotatable shaft and a cam follower connected to the pivoting drive arm which engages with the camand follows the path of the cam when the shaft is rotated; characterised in that a spring is provided, one end of which is fixedly connected to the end, remote from the pivot point, of the pivoting drive arm, the other end of which is fixedly connected striker.

### FIELD OF THE INVENTION

The present invention relates to powered hammers, to powered rotary hammers, and to power drills having a hammer action.

### BACKGROUND OF THE INVENTION

DE4121279 forms the closest piece of prior art and forms the basis of the pre-characterising portion of claim 1.

DE4121279 describes a hammer which comprises a ram 24 (using the same reference numbers as DE4121279) which is slideably mounted within the main housing of the hammer and which can be reciprocatingly driven via a pivotal arm 20 which is pivotally mounted within the housing at one about a pivot 16. The pivotal arm 20 is pivotally driven by the motor via a pivotal drive mechanism which converts the rotary movement generated by the motor into a pivotal movement of the arm 20. The ram 24 strikes a beat piece 28 which in turn strikes the end of a cutting tool 25.

One problem associated with the design is that the method by which the end 21 of the pivotal arm 20 is connected to the ram 24. As can be seen on FIGS. 1 and 3 of DE4121279, the end 21 of the arm 20 surrounds the ram 24. Two ribs 22, 23 are formed on the ram 24 between which the end 21 of the arm 20 can freely slide. Thus the ram 24 can slide within the arm 20, the amount of movement being limited by the ribs 22, 23 ie the arm 20 is non fixedly connected to the ram. This results in a limited range of free movement of the ram 24 relative to the pivoting arm 20. As such the control of the ram 24 during the hammering operation is diminished.

### BRIEF SUMMARY OF THE INVENTION

The present invention seeks to overcome this problem by connecting the end of the arm to the ram via a spring. This results in the ram and arm being in constant connection with each other whilst allowing relative movement between the two. The movement of the ram is much more controlled by the arm during the hammering operation due to the spring. The spring further urges the ram and the end of the arm to predetermined positions relative to each other.

EP0145070, GB2295347 and U.S. Pat. No. 5,337,835 are also relevant pieces of prior art.

Accordingly there is provided a hammer comprising:

a housing;

a motor mounted within the housing;

a tool holder rotatably mounted on the housing for holding a cutting tool;

a striker mounted in a freely slideable manner within the housing, for repetitively striking an end of a cutting tool when a cutting tool is held by the tool holder, which striker is reciprocatingly driven by the motor, when the motor is activated, via a drive mechanism;

wherein the drive mechanism comprises:

a pivoting drive arm pivotally mounted within the housing at one end;

a pivotal drive mechanism connected to the pivoting drive arm which converts a rotary movement generated by the motor to a pivoting movement of the pivoting drive arm about its pivot point, the pivotal drive comprising a circular cam formed around the circumference of a lengthwise section of a rotatable shaft and a cam follower connected to the pivoting drive arm which engages with cam and follows the path of the cam when the shaft is rotated;

characterised in that a spring is further provided, one end of which is fixedly connected to an end remote from the pivot point, of the pivoting drive arm, the other end being fixedly connected to the striker.

Such a construction can be utilised both in rotary hammers which can perform a drilling function, chiselling function or a combination of the two, and in hammers which can perform a chiselling function only.

### BRIEF DESCRIPTION OF THE DRAWINGS

Two embodiments of the present invention will now be described with reference to the accompanying drawings of which:

FIG. 1 shows a perspective view of a percussion drill;

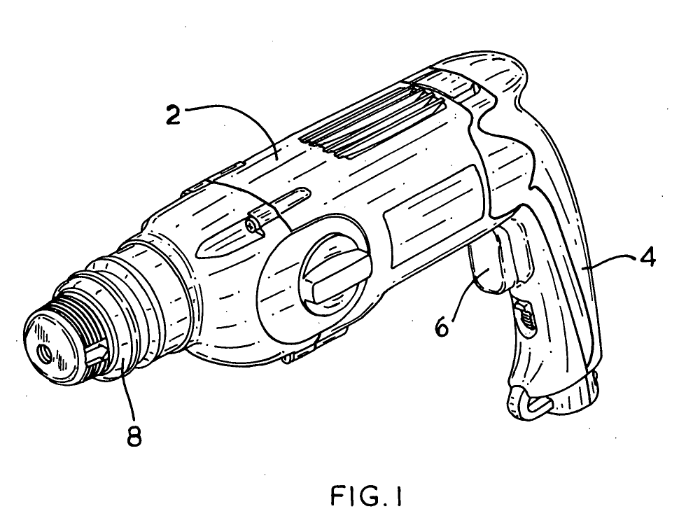

FIGS. 2 and 2A are views of a hammer mechanism;

FIG. 3 is a view of a hammer mechanism of a first embodiment of the present invention; and

FIG. 4 is a view of the second embodiment of the present invention.

### DETAILED DESCRIPTION OF THE INVENTION

A hammer drill comprises a housing 2 in which is mounted a motor (not shown). A handle 4 is attached to the rear of the housing which can be activated using a trigger switch 6. A tool holder is mounted on the front of the housing 2. The tool holder 8 holds a cutting tool (not shown) such as a drill bit. The motor reciprocatingly drives a ram which in repetitively impacts the end of a cutting tool, via a beat piece, when located within the tool holder in well known manner.

The present invention concerns the mechanism by which the rotary drive generated by the motor is converted into a reciprocating movement of the ram within a hammer. Two embodiments of the present invention will be described.

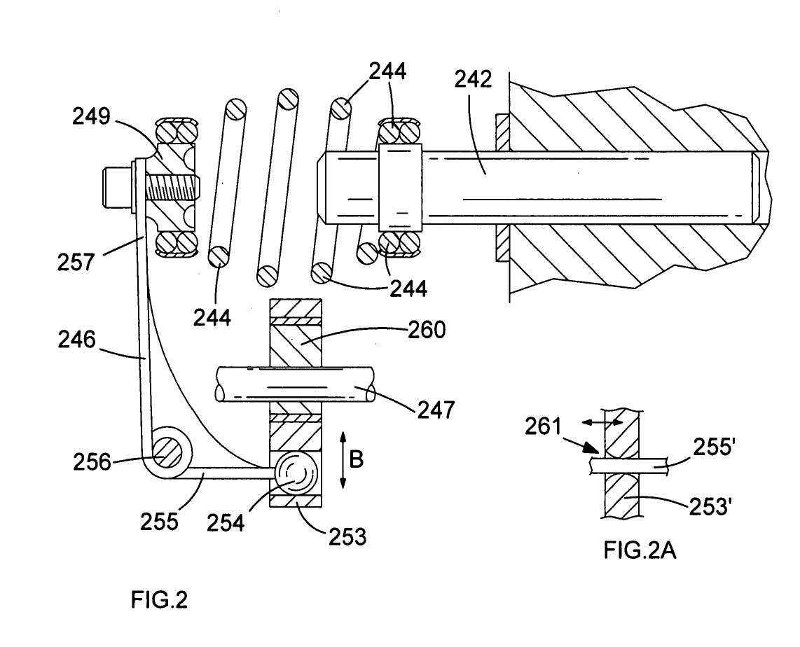

FIG. 2 shows an example of a hammer mechanism. A shaft 247 is rotatable by means of a motor (not shown) and rigidly carries an eccentrically mounted circular disk 260. The central axis of the disk 260 is parallel to but not co-axial with the longitudinal axis of the shaft 247. As the shaft 247 rotates, the axis of the disk rotates about the axis of the longitudinal axis of the shaft 247.

A yolk 253 surrounds the disk 260 which converts the rotational movement of the disk 260 into a vertical oscillating movement in the direction of Arrow B. The lower section of the yolk 253 comprises a recess which receives a ball 254 slidably mounted on a first arm 255 of a torsion spring 246 pivotally mounted about a support 256. As a result, rotation of the shaft 247 by means of the motor causes the end of the first arm 255 of torsion spring 246 to oscillate in a vertical direction as shown in FIG. 2, which in turn causes horizontal oscillation of a support 249 mounted to the end of a second arm 257 of the torsion spring 246. This oscillating motion of the support 249 is transferred via a helical spring 244 of convex axial cross section to a ram 242 to impart impacts to a beat piece (not shown) which in turn strikes the end of drill bit held by the tool holder 8. The convex axial cross section results in the spring 244 having an envelope convexly shaped along its length ie the diameter of the spring 244 at its centre is greater than either at its ends. The amplitude of oscillation of the end of the first arm 255 of torsion spring 246 (and therefore of the support 249 at the end of the second arm 257 of torsion spring 246) is adjusted by axially displacing the yolk 253, together with the ball 254, along the shaft 247. The hammer mechanism will be constructed such that the disk 260 remains, at least partially, within the yolk in all positions.

Alternatively, the ball 254 could be absent and the end of the first arm 255′ slidably fit within a narrower aperture 261 in the yolk 253′, as shown in FIG. 2A. The inner walls of the aperture 261 can be convex to accommodate the pivotal movement of the first arm 255′.

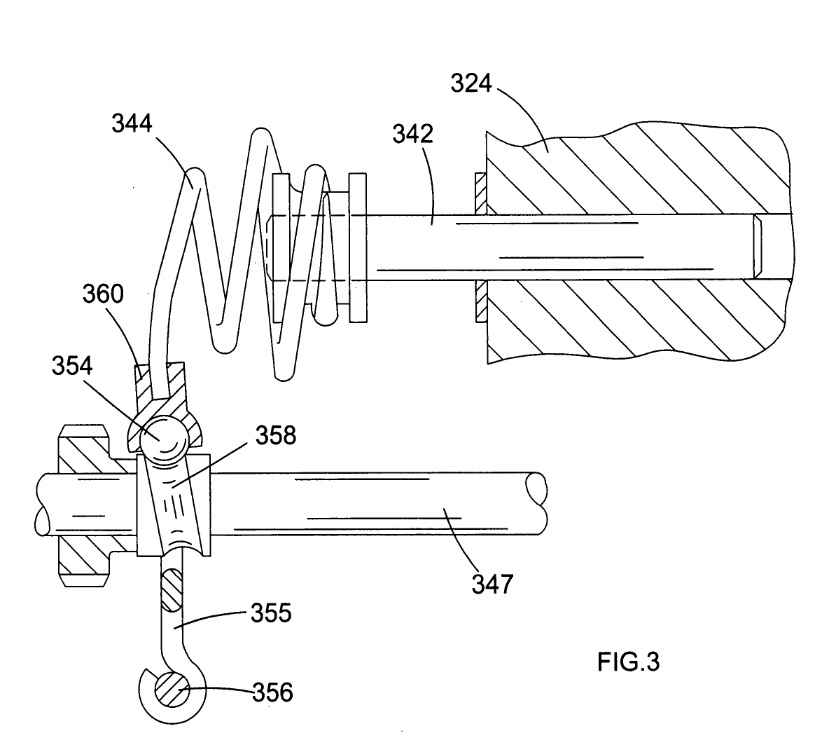

Referring to FIG. 3, a hammer mechanism of a first embodiment of the invention is provided with a mechanical helical spring 344 supporting a ram 342 at one end thereof. The ram 342 is rigidly connected to the end of the spring 344 so that there is relative movement between the end of the spring 344 and the ram 342. The other end of the spring 344 is mounted to first end 360 of a rigid arm 355, the second end of which is pivotably mounted to a support 356. The arm 355 support carries a ball bearing 354 which is received within an inclined groove 358 on a shaft 347, such that rotation of the shaft 347 by means of the motor (not shown) causes axial oscillation of the ball bearing 354 relative to the housing as it follows the groove 358, which in turn causes axial oscillation of the ram 342 relative to the spindle 324 to impart impacts to a drill bit (not shown). The shape of the envelope of the spring 344 along its length is convex, the spring being fatter at its mid point than at either of its ends.

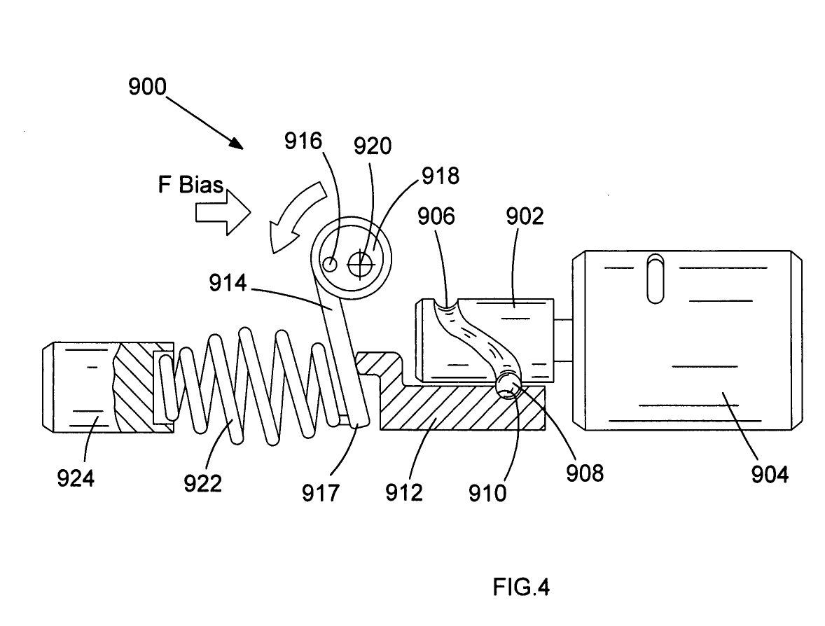

Referring to FIG. 4, a hammer mechanism 900 of a second embodiment of the invention and comprises an output gear 902 driven by means of a motor and gear box 904. The output gear 902 has a continuous sinusoidal groove 906 which receives a ball bearing 908 received within a recess 910 in a drive member 912. The drive member can freely slide horizontally backwards and forwards (right and left in FIG. 6) but is prevented from any other type of movement. As such, one complete rotation of the output gear 902 causes one complete axial horizontal oscillation of the drive member 912. The drive member 912 abuts against the side of an arm 914, which is pivotable about a pivot 916 on an eccentric gear 918 mounted about an axis 920. By rotation of the gear 918 about the axis 920, the position at which the drive member 912 engages the arm 914 relative to the pivot 916 can be adjusted, which in turn adjusts the amplitude of oscillation of the distal end 917 of the arm 914. A spring 922 connected to the distal end 917 of the arm 914 transfers the reciprocating movement of the drive member 912 to a ram 924 located in a hollow spindle (not shown) to impart impacts to the tool bit.

1. A hammer comprising:
a housing 2;
a motor mounted within the housing;
a tool holder 8 rotatably mounted on the housing 2 for holding a cutting tool;
a striker 342; 924 mounted in a freely slideable manner within the housing, for repetitively striking an end of a cutting tool when a cutting tool is held by the tool holder 8, which striker is reciprocatingly driven by the motor, when the motor is activated, via a drive mechanism;
wherein the drive mechanism comprises:
a pivoting drive arm 355; 914 pivotally mounted within the housing 2 at one end;
a pivotal drive mechanism connected to the pivoting drive arm 355; 914 which converts a rotary movement generated by the motor to a pivoting movement of the pivoting drive arm 355; 914 about its pivot point, the pivotal drive mechanism comprising a circular cam 358; 906 formed around the circumference of a length wise section of a rotatable shaft 347; 902 and a cam follower 354; 908 connected to the pivoting drive arm 355; 914 which engages with cam 358; 906 and follows the path of the cam 358; 906 when the shaft 347; 902 is rotated;
characterised in that a spring 244; 344; 444; 844; 922 is further provided, one end of which is fixedly connected to an end, remote from the pivot point, of the pivoting drive arm 246; 355; 457, 857; 914 the other end being fixedly connected to the striker 342; 924.

2. A hammer as claimed in claim 1 wherein the spring 344; 922 is helical.

3. A hammer as claimed in either of claims 1 or 2 wherein the longitudinal axis of the spring 344; 922 is parallel to or co-axial with that of the striker 342; 924.

4. A hammer as claimed in any one of the previous claims wherein the shape of the envelope of the spring 344; 922 along its length is convex.

5. A hammer as claimed in any one of the previous claims wherein the position along the length of either the pivoting drive arm 914 where the pivotal drive mechanism engages the pivoting drive arm 914 can be altered relative to the position of the pivot point.

6. A hammer as claimed in any of the previous claims wherein the cam 358; 906 is a channel.

7. A hammer as claimed in claim 6 wherein the channel 358; 906 is an inclined groove.

8. A hammer as claimed in any one of the previous claims wherein the cam follower 354 is mounted on the pivoting drive arm 355.

9. A hammer as claimed in any one of the previous claims wherein the cam follower 354; 908 is a ball bearing.
